(19) United States
(12) Patent Application Publication
(10) Pub. No.: US 2024/0336384 A1
(43) Pub. Date: Oct. 10, 2024

(54) UNWINDING APPARATUS FOR A WRAPPING MACHINE

(71) Applicant: ROBOPAC S.P.A., Acquaviva-Gualdicciolo (SM)

(72) Inventors: Marco MORRI, Acquaviva-Gualdicciolo (SM); Fabio TOMA, Acquaviva-Gualdicciolo (SM)

(21) Appl. No.: 18/580,886

(22) PCT Filed: Jul. 20, 2022
(86) PCT No.: PCT/IB2022/056704

§ 371 Date: Jan. 19, 2024

(30) Foreign Application Priority Data
Jul. 21, 2021 (IT) 102021000019337

(51) Int. Cl. B65B 41/16; B65B 11/00; B65B 65/02

(52) U.S. Cl. CPC B65B 41/16; B65B 11/00; B65B 65/02; B65B 2011/002

(57) ABSTRACT

An unwinding apparatus has first and second pre-stretching rollers and a motion transmission system for transmitting a rotation motion from the first pre-stretching roller to the second pre-stretching roller. The motion transmission system has two toothed driving wheels rotated by the first pre-stretching roller, two toothed driven wheels selectively couplable to the second pre-stretching roller, and a selector device operable to couple a toothed driven wheel to the second pre-stretching roller. The selector device has a driven shaft provided with a longitudinal internal cavity having first and second lateral through openings suitable for housing respective locking elements. A selector pin provided with first and second transverse protrusions is movable inside the internal cavity between a first operative position, in which a first toothed driven wheel is coupled to the driven shaft, and a second operative position, in which a second toothed driven wheel is coupled to the driven shaft.

The invention relates to machines and apparatuses for wrapping a load with a film of extensible plastic material and in particular it concerns an unwinding apparatus associable with a wrapping machine.

It is known in the packaging industry to wrap a load formed by a single product or by a plurality of products grouped on a pallet with a film of cold extensible plastic material.

In particular, the known wrapping machines comprise an unwinding apparatus which is movable along and/or about a wrapping axis and which supports a reel of film from which the film is unwound to be wrapped around the load so as to form a series of strips or bands generally having a helical arrangement, thanks to the combination of the relative linear and rotating movements between the unwinding apparatus and the load.

In wrapping machines provided with a rotating table to support the load, the load during the wrapping process is rotated together with the table about a vertical wrapping axis, while the unwinding apparatus is moved parallel to the wrapping axis with alternating motion along a fixed upright of the wrapping machine.

In self-propelled wrapping machines, the unwinding apparatus is moved with alternating motion along an upright fixed to a mobile carriage of the self-propelled wrapping machine which rotates around the load that remains stationary during the wrapping.

In wrapping machines with horizontal rotating ring or rotating arm, the load remains stationary during the wrapping, while the unwinding apparatus is moved with respect to the load both in rotation about a vertical wrapping axis and in translation along the vertical wrapping axis. To this end, the unwinding apparatus is fixed to a ring structure or to an arm that is rotatably supported by a machine frame and so as to rotate around the load.

In wrapping machines with vertical rotating ring the load is moved horizontally through the ring, while the unwinding apparatus fixed to the ring is rotated about a horizontal axis.

The unwinding apparatus supports the reel of film and is generally provided with a pair of pre-stretching rollers, comprising a slow roller and a fast roller, respectively upstream and downstream with reference to the film movement, to stretch and unwind the film, and with one or more guiding rollers to deflect the film towards the load during the unwinding.

By suitably adjusting a difference between the rotational speeds of the two pre-stretching rollers, it is possible to stretch or elongate by a defined amount, according to a settled pre-stretch or elongation percentage, the film leaving the unwinding apparatus before it is wrapped around the load.

The plastic film is stretched before being wrapped around the load since stretching, or elongation, allows better using the film and giving the film physical-mechanical features such as to make it more suitable to withstand the forces acting on the load during the subsequent handling and transport. In particular, when the stretching force ceases, the elastic return of the film causes a clamping force around the load which ensures its containment.

The stretching is generally expressed in percentage terms as the ratio between the elongation of the film (difference between the final length of the stretched film and the film original length) and the film original length. Typically the elongation imparted to the film is between 50 and 300%.

The elongating or pre-stretching force exerted by the pre-stretching rollers makes it possible to significantly reduce the thickness of the film so as to proportionally increase its length in order to wrap a longer perimeter of load with the same initial amount of unwound film and also allows the mechanical characteristics of the film to be changed.

The pre-stretching force to which the film is subjected in order to obtain a settled elongation ratio or percentage depends on the type of load to be wrapped (e.g. more or less stable products) and on a plurality of elements such as initial thickness of the film, physical-mechanical features of the plastic material of the film (type of material, composition, quantity and distribution of any internal impurities and inhomogeneities), environmental conditions (temperature, humidity) in which the load is wrapped.

For driving the pre-stretching rollers, unwinding apparatuses are known that comprise an electric motor which rotates one of the two pre-stretching rollers that acts as a driving roller (typically the fast roller) and, through a mechanical motion transmission assembly, the other pre-stretching roller that acts as a driven roller (typically the slow roller). In this way, a settled transmission ratio is imposed between the fast roller and the slow roller, according to a desired pre-stretching or elongation value or percentage to be obtained on the film.

The mechanical transmission assembly is substantially a speed reducer that connects the shaft of the fast roller to the shaft of the slow roller reducing the rotation angular speed of the slow roller with respect to the rotation angular speed of the fast roller.

The transmission assembly generally consists of gears comprising a series of toothed wheels having different number of teeth and meshing with each other. Alternatively, the transmission assembly can be formed by a pair of toothed pulleys, having a different number of teeth, coupled to each other by a belt, also toothed.

To change the film pre-stretching value or percentage during the usage of the wrapping machine according to characteristics of load to be wrapped, of the film, environmental conditions, etc., it is therefore necessary to change the speed or transmission ratio of the transmission assembly, i.e. replace one or more toothed wheels or pulleys.

Although toothed wheels and pulleys in some known unwinding apparatuses are configured to be quickly assembled/disassembled, their replacement is however laborious and in addition to causing the wrapping machine to stop for a considerable period of time it requires an expert operator.

An object of the present invention is to improve the known unwinding apparatuses associable with wrapping machines for wrapping a load with a film of extensible plastic material.

Another object is to provide an unwinding apparatus that allows to quickly and easily change the pre-stretching or elongation percentage of the film with which to wrap a load.

A further object is to carry out an unwinding apparatus having a low-complexity and economical construction and precise and reliable operation.

These and further objects are achieved by an unwinding apparatus according to one or more of the claims set out below.

The unwinding apparatus according to the invention that is associable with a wrapping machine and arranged to deliver a film of extensible plastic material comprises a first pre-stretching roller and a second pre-stretching roller rotatable about respective longitudinal rotation axes and arranged to unwind and pre-stretch the film, a motion transmission system configured to connect the pre-stretching rollers and transmit a rotation motion from the first pre-stretching roller to the second pre-stretching roller with at least one defined transmission ratio. The motion transmission system comprises at least two toothed driving wheels having different respective numbers of teeth, mounted coaxial and integral to each other, and rotated by the pre-stretching roller, at least two toothed driven wheels having different respective numbers of teeth, mounted coaxial to the second pre-stretching roller and selectively couplable to the second pre-stretching roller, each toothed driven wheel meshing with a respective toothed driving wheel in order to transmit the rotation motion of the first pre-stretching roller to the second pre-stretching roller with a corresponding transmission ratio when it is coupled to the second pre-stretching roller, and selector means operable to couple a toothed driven wheel at a time to the second pre-stretching roller.

The selector means comprise a driven shaft connected to the second pre-stretching roller, rotatably supporting the toothed driven wheels and provided with a longitudinal internal cavity having at least one first lateral through opening and one second lateral through opening suitable for housing respective locking elements, a selector pin sliding inside the internal cavity and provided with a first transverse protrusion and a second transverse protrusion; the selector pin is movable between a first operative position, in which the first transverse protrusion abuts and pushes at least one locking element to protrude externally from the first lateral through opening so as to engage a first seat of the first toothed driven wheel and to couple the first toothed driven wheel to the driven shaft, and a second operative position, in which the second transverse protrusion abuts and pushes at least one locking element to protrude externally from the second lateral through opening so as to engage a second seat of the second toothed driven wheel and to couple the second toothed driven wheel to the driven shaft.

Thanks to the unwinding apparatus of the invention it is therefore possible to quickly and easily change a transmission ratio of the pre-stretching rollers. In fact, each toothed driven wheel by meshing with a respective toothed driving wheel, when it is coupled and made integral with the driven shaft that is connected to the second pre-stretching roller, is able to transmit to the second pre-stretching roller the rotation motion of the first pre-stretching roller according to a corresponding transmission ratio, that depends on the number of teeth of the said toothed driven and driving wheels. By acting on the selector pin of selector means, which is provided with transverse protrusions acting on locking elements able to lock a desired toothed driven wheel to the driven shaft, it is in fact possible to couple and make integral a desired driven wheel to the driven shaft and therefore to the second pre-stretching roller.

The invention can be better understood and implemented with reference to the attached drawings which illustrate exemplifying and non-limiting embodiments thereof, in which:

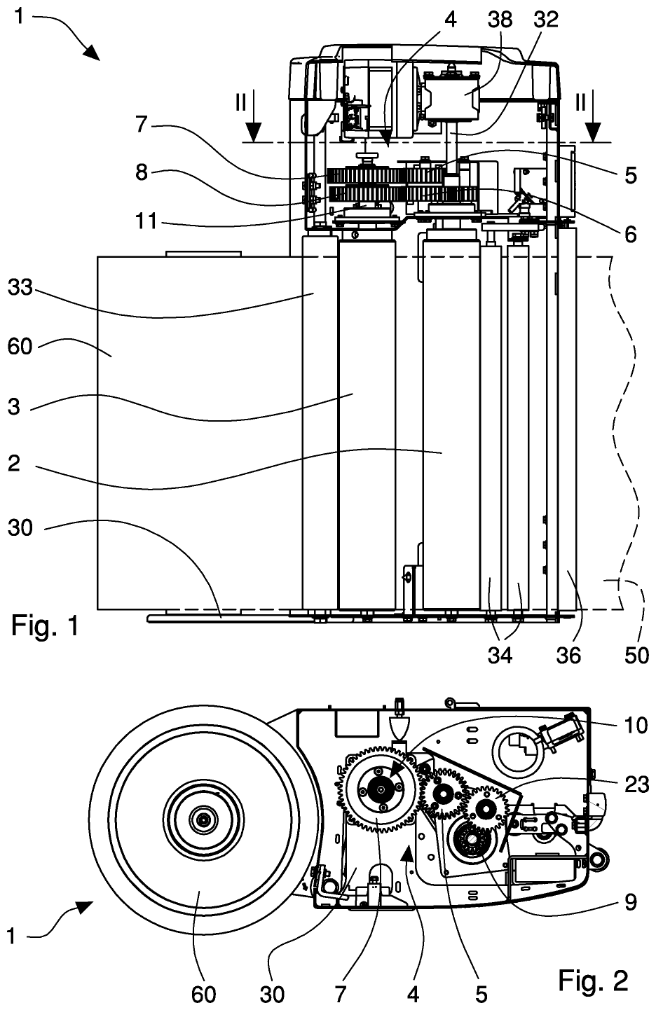

FIG. 1 is a front view of the unwinding apparatus of the invention supporting a reel of film;

FIG. 2 is a section according to line II-II of FIG. 1;

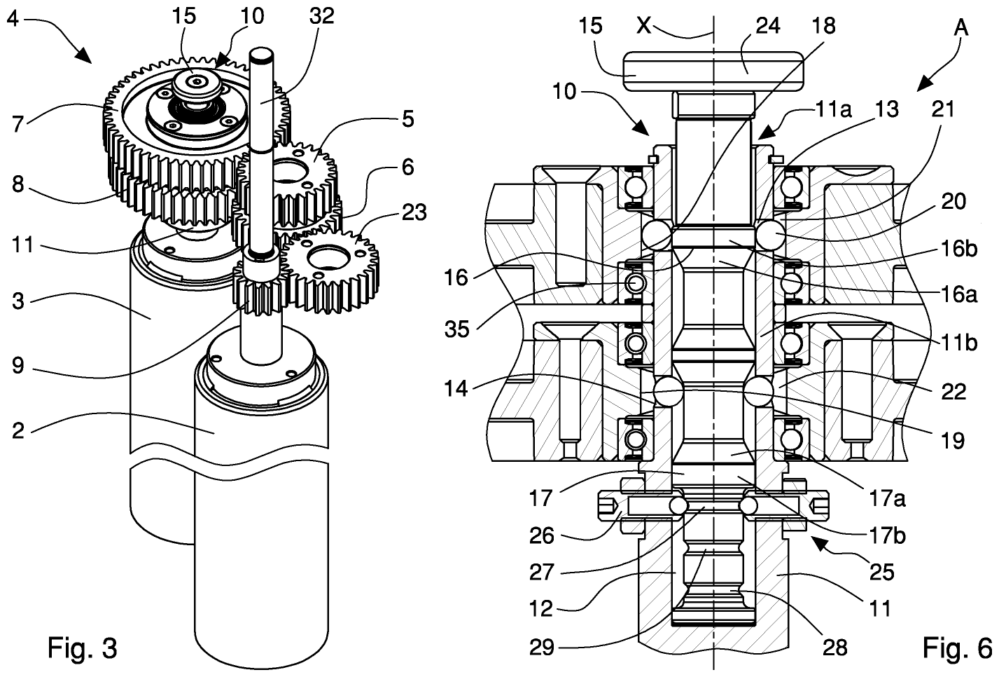

FIG. 3 is an enlarged partial perspective view of pre-stretching rollers and a motion transmission system of the unwinding apparatus of FIG. 1;

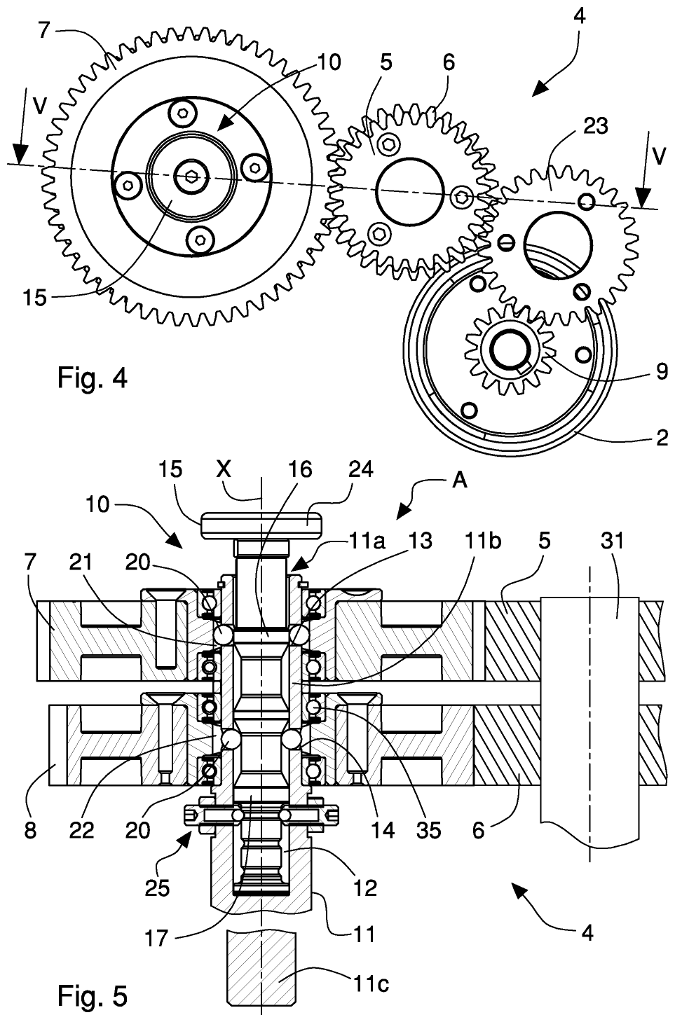

FIG. 4 is a top plan view of the pre-stretching rollers and motion transmission system of FIG. 3;

FIG. 5 is a partial enlarged section according to line V-V of FIG. 4 with a selector element of the motion transmission system in a first operative position;

FIG. 6 is an enlarged detail of the section of FIG. 5;

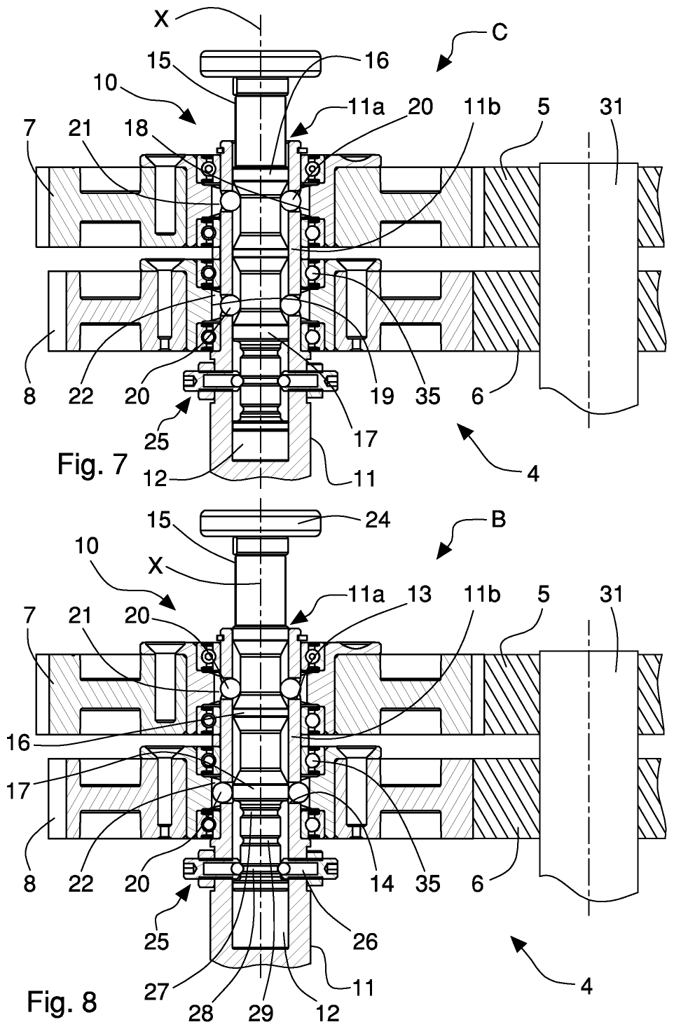

FIG. 7 is a section like the one of FIG. 5 in which the selector element is in an inoperative position

FIG. 8 is a view like the one of FIG. 5 in which the selector element is in a second operative position.

FIG. 1 illustrates the unwinding apparatus 1 of the invention that is associable with a wrapping machine, not illustrated, and arranged to deliver a film 50 of extensible plastic material that is unwound from a reel 60 and to be wrapped around a load, which is formed for example by one or more products grouped on a pallet The unwinding apparatus 1 comprises a first pre-stretching roller 2 and a second pre-stretching roller 3 rotatable about respective longitudinal rotation axes and arranged to unwind and pre-stretch the film 50. The unwinding apparatus 1 also comprises a plurality of guiding rollers 33, 34, 36 which deflect the film from the reel 60 towards the pre-stretching rollers 2, 3 and from the pre-stretching rollers out from the unwinding apparatus 1 towards the load to be wrapped. More precisely, the unwinding apparatus 1 comprises a first guiding roller 33 which deflects the film 50 that is unwound from the reel 60 towards the second pre-stretching roller 3 and second and third guiding rollers 34, 36 which deflect the film 50 leaving the first pre-stretching roller 2 towards the load to be wrapped.

The pre-stretching rollers 2, 3 are rotatably mounted on a supporting frame 30 of the unwinding apparatus 1 which also rotatably supports the reel of film 60.

The unwinding apparatus 1 further comprises a motion transmission system 4 configured to connect, in particular to mechanically couple, the pre-stretching rollers 2, 3 to each other and transmit a rotation motion from the first pre-stretching roller 2 to the second pre-stretching roller 3 with one or more defined transmission ratios. More precisely, the motion transmission system 4, rotated by the first pre-stretching roller 2, which is for example the roller that rotates faster (fast roller) at a first angular or rotational speed, rotates the second pre-stretching roller 3 (slow roller) at a second angular or rotational speed lower than the first angular speed.

The motion transmission system 4 comprises two or more toothed driving wheels 5, 6, having different respective numbers of teeth, mounted coaxial and integral to each other and rotated by the first pre-stretching roller 2. The toothed driving wheels 5, 6 are mounted and fixed to a supporting shaft 31 that is rotatably supported by the supporting frame 30 of the unwinding apparatus 1. In the embodiment of the figures, the motion transmission system 4 comprises a first toothed driving or primary wheel 5 and a second toothed driving or primary wheel 6.

The motion transmission system 4 also comprises two or more driven or secondary toothed wheels 7, 8 having different respective numbers of teeth, mounted coaxial to the second pre-stretching roller 3 and selectively couplable (i.e. which can be selectively coupled) to the second pre-stretching roller; each toothed driven wheel 7, 8 meshes with a respective driving toothed wheel 5, 6 so as to transmit the rotation motion from the first pre-stretching roller 2 to the second pre-stretching roller 3 with a corresponding transmission ratio, when the toothed driven wheel 7, 8 is coupled to the second pre-stretching roller 3.

The transmission ratio is related to the number of teeth of the said toothed driven and driving wheels.

In the embodiment of figures, the motion transmission system 4 comprises a first toothed driving wheel 5 and a second toothed driving wheel 6.

The number of toothed driven wheels 7, 8 is equal to the number of toothed driving wheels 5, 6.

The first driving wheel 5 and the first driven wheel 7, meshing with each other, carry out a first transmission ration between the pre-stretching rollers 2, 3, while the second driving wheel 6 and the second driven wheel 8, meshing with each other, carry out a second transmission ratio between the pre-stretching rollers 2, 3.

The motion transmission system 4 further comprises selector means 10 that can be operated, for example manually by an operator, to selectively couple and connect a toothed driven wheel 7, 8 at a time to the second pre-stretching roller 3.

More precisely, the selector means 10 are configured to couple and make integral with the second pre-stretching roller 3 the first toothed driven wheel 7 or the second toothed driven wheel 8, depending on the operating needs.

The selector means 10 comprise a driven or secondary shaft 11 which is connected to the second pre-stretching roller 3, so as to rotate with the second pre-stretching roller about its longitudinal axis, and which rotatably supports the toothed driven wheels 7, 8. The driven shaft 11 is provided with a longitudinal internal cavity 12, in particular a blind internal cavity, having one or more first lateral through openings 13 and one or more second lateral through openings 14 suitable for housing respective locking elements 20. The first through openings 13 and the second through openings 14 are in particular openings orthogonal to a central longitudinal axis X of the driven shaft 11, that coincides with a rotation axis of said driven shaft. The first through openings 13 and the second through openings 14 are for example circular-shaped radial openings made on a lateral tubular wall 11b of the driven shaft 11. The first through openings 13 and the second through openings 14 are spaced to each other along a direction parallel to the longitudinal axis X of the driven shaft 11.

In the embodiment illustrated in figures, the internal cavity 12 of the driven shaft 11 comprises a plurality of first through openings 13 that are angularly spaced about the longitudinal axis X of driven shaft 11, in particular lying on a respective plane that is orthogonal to the longitudinal axis X, and suitable for housing respective locking elements 20. The internal cavity 12 also comprises a plurality of second through openings 14 angularly spaced about the longitudinal axis X, in particular lying on a respective plane that is orthogonal to the longitudinal axis X, and suitable for housing respective locking elements 20. The locking elements 20 comprise respective spherical elements.

The selector means 10 comprise a selector pin 15 sliding inside the internal cavity 12 and provided with a first transverse protrusion 16 and a second transverse protrusion 17. The transverse protrusions 16, 17 lie on respective planes almost orthogonal to the longitudinal axis X of the driven shaft 11.

The selector pin 15 comprises a gripping end 24, in particular knob-shaped, which protrudes from an access opening 11a of the internal cavity 11, said access opening 11a being positioned on the side opposite to the second pre-stretching roller 3. More precisely, the access opening 11a is made on a first end of the driven shaft 11 which is opposite to a second end 11c of the driven shaft 11 which is connected to the second pre-stretching roller 3.

The selector pin 15 is movable, in particular manually, at least between a first operative position A and a second operative position B.

In the first operative position A, the first transverse protrusion 16 of the selector pin 15 abuts and pushes one or more locking elements 20 to protrude externally from the respective first through openings 13 in order to engage respective first seats 21 of the first toothed driven wheel 7 so as to couple and make the first toothed driven wheel 7 integral with the driven shaft 11, in particular preventing a relative rotation between the first toothed driven wheel 7 and the driven shaft 11.

In the second operative position B, the second transverse protrusion 17 of the selector pin 15 abuts and pushes one or more locking elements 20 to protrude externally from the second through openings 14 so as to engage second seats 22 of the second toothed driven wheel 8 in order to couple and make the second toothed driven wheel 8 integral with the driven shaft 11, in particular preventing a relative rotation between the second toothed driven wheel 8 and the driven shaft 11.

The first lateral through openings 13 and the second lateral through openings 14 of the driven shaft 11 face respectively the first seats 21 of the first toothed driven wheel 7 and the second seats 22 of the second toothed driven wheel 8.

The selector pin 15 has for example a cylindrical shape, and the shape of the internal cavity 12 of the driven shaft 11 is cylindrical too, and the transverse protrusions 16, 17 are annular protrusions and each comprise a conical portion 16a, 17a and a cylindrical portion 16b, 17b respectively to push and guide the locking element 20 to protrude externally from the through openings 13, 14 and to keep the locking member 20 protruding externally from the through openings 13, 14 in the operative positions A, B. The conical portion 16a, 17a of each transverse protrusion 16, 17 further guides the locking element inside the respective through opening 13, 14 when the selector pin 15 is moved.

The first toothed driven wheel 7 and the second toothed driven wheel 8 respectively comprise a first through opening or hub 18 and a second through opening or hub 19 suitable for rotatably coupling, in particular by interposition of rolling bearings 35, with the driven shaft 11. The first through opening 18 and the second through opening 19 are provided with a plurality respectively of first seats 21 and second seats 22 suitable for receiving the locking elements 20. The first seats 21 and the second seats 22 comprise respective recesses radially made on internal cylindrical walls of the through opening 18, 19.

The selector pin 15 is also movable in an inoperative position C in which the first transverse protrusion 16 and the second transverse protrusion 17 do not abut the locking elements 20 so that the toothed driven wheels 7, 8 can idly rotate on the driven shaft 11. In this inoperative position C of the selector pin 15, the second pre-stretching roller 3 is not rotated by the first pre-stretching roller 2.

The selector means 10 comprise locking means 25 acting on the selector pin 15 and configured to reversibly lock it at least in the first operative position A or in the second operative position B and to avoid undesired axial displacements of the said selector pin 15 inside the internal cavity 12 during the operation of the wrapping apparatus 1.

The locking means 25 comprise one or more elastic pressing elements 26, for example two spring pressing elements fixed to the driven shaft 11 and a first annular groove 27 and a second annular groove 28 made on the selector pin 15. The elastic pressing elements 26 are configured to engage the first annular groove 27 or the second annular groove 28 respectively in the first operative position A and in the second operative position B of the selector pin 15. The elastic pressing elements 26 of the known type and not described in detail comprise a stop element sliding inside a supporting element and kept in a protruding position by a spring.

The locking means 25 further comprise a third annular groove 29 made on the selector pin 15 and interposed between the first annular groove 27 and the annular groove 28 which is engaged by the elastic pressing elements 26 when the selector pin 15 is arranged in the inoperative position C. In this way the locking means 25 reversibly locks the selector pin 15 even in the inoperative position C.

The unwinding apparatus 1 comprising a motor 38, in particular a rotary electric motor, arranged to rotate the first pre-stretching roller 2. More precisely, the motor 38 is connected to the first pre-stretching roller 2 by a driving or primary shaft 32.

The motion transmission system 4 comprises a third toothed driving wheel 9 coaxially fixed to the first pre-stretching roller 2 and acting, in particular by means of an interposed idle toothed wheel 23, on one of the toothed driving wheels 5, 6, for example the second toothed driving wheel 6. The third toothed driving wheel 9 is fixed and integral with the driving shaft 32.

The operation of the unwinding apparatus 1 of the invention provides in an initial phase of adjustment of the wrapping machine on which the unwinding apparatus is installed, to select the transmission ratio between the pre-stretching rollers 2, 3, which is required according to a pre-stretching or elongation percentage to be achieved on the film 50 during wrapping, by acting on the selector means 10 of the motion transmission system 4.

More precisely, if a first transmission ratio is required between the pre-stretching rollers 2, 3, the operator moves the selector pin 15 into the first operative position A in order to couple and make integral with the driven shaft 11, and then with the second pre-stretching roller 3, the first toothed driven wheel 7, which meshes with the first driving toothed wheel 5 by which it is rotated, when the first pre-stretching roller 2 is rotated by the motor 38.

In the first operative position A of the selector pin 5 the first transverse protrusion 16 abuts and pushes the locking elements 20 so as to protrude externally from the first lateral through openings 13 of the internal cavity 12 of the driven shaft 11 and engage the first seats 21 of the first toothed driven wheel 7 so as to couple and make the first toothed driven wheel 7 integral with the driven shaft 11.

If a second transmission ratio is required between the pre-stretching rollers 2, 3, the operator moves the selector pin 15 into the second operative position B in order to couple and make integral with the driven shaft 11, and then with the second pre-stretching roller 3, the second toothed driven wheel 8, which meshes with the second toothed driving wheel 6 by which it is rotated, when the first pre-stretching roller 2 is rotated by the motor 38.

In the second operative position B of the selector pin 5 the second transverse protrusion 17 abuts and pushes the locking elements 20 so as to protrude externally from the second lateral through openings 14 of the internal cavity 12 of the driven shaft 11 and engage the second seats 22 of the second toothed driven wheel 8 so as to couple and make the second toothed driven wheel 8 integral with the driven shaft 11.

In a variant of the unwinding apparatus 1 of the invention not shown in figures, the motion transmission system 4 can comprise three or more toothed driving wheels, mounted coaxial and integral to the supporting shaft 31 and a corresponding number of toothed driven wheels also mounted coaxial, but selectively and alternatively couplable to the driven shaft 11 connected to the second pre-stretching roller 3.

The selector means 10 in this variant comprise three or more plurality of lateral through openings, spaced apart along a direction parallel to a longitudinal axis X of the driven shaft 11. The lateral through openings of each of the plurality of lateral through openings are angularly spaced about the longitudinal axis X and facing the seats of a respective toothed driven wheel.

Similarly, the selector pin 15 comprises a number of transverse protrusions at least equal to the number of lateral through openings, i.e. of toothed driven wheels. Each transverse protrusion is associable with a respective plurality of lateral through openings and in particular is configured to abut and push the locking elements 20 so as to protrude externally from the aforesaid respective through openings and engage the seats 22 of the corresponding toothed driven wheel so as to couple and make the toothed driven wheel integral to the driven shaft 11.

The unwinding apparatus 1 of the invention that is associable with a wrapping machine to deliver a film of extensible plastic material allows to quickly and easily change the pre-stretching or elongation percentage or value of the film, that is to change the transmission ratio between the two pre-stretching rollers 2, 3, in particular to change the rotation speed of the second pre-stretching roller 3 while keeping the rotation speed of the first pre-stretching roller 2 unchanged.

Thanks to the motion transmission system 4 of the unwinding apparatus 1, which comprises at least one pair of driving wheels 5, 6 having different numbers of teeth and driven by the first pre-stretching roller 2 and a pair of toothed driven wheels 7, 8 having different respective numbers of teeth and that can be selectively coupled to the second pre-stretching roller 3 by means of the selective means 10, it is in fact possible to quickly and easily change the transmission ratio between the pre-stretching rollers 2, 3.

Each toothed driven wheel 7, 8 by meshing with a respective toothed driving wheel 5, 6 when it is coupled and made integral with the driven shaft 11, connected to the second pre-stretching roller 3, is able to transmit to the second pre-stretching roller 3 the rotation motion of the first pre-stretching roller 2 according to a corresponding transmission ratio, related to the number of teeth of the said toothed driving and driven wheels.

By acting on the selector pin 15 of the selector means 10, provided with transverse projections 16, 17 acting on locking elements 20 capable to lock a desired toothed driven wheel 7, 8 to the driven shaft 11, it is in fact possible to couple and make integral a desired driven wheel 7, 8 to the driven shaft 11 and therefore to the second pre-stretching roller 3.

Correct positioning and stability of the selector pin 15 in the operative positions A, B are ensured by the locking means 25 comprising a plurality of elastic pressing elements 26 capable of reversibly engaging annular grooves 27, 28 made on the selector pin 15 and corresponding to the respective operative positions A, B to be maintained.

1-11. (canceled)

12. An unwinding apparatus associable with a wrapping machine and arranged to deliver a film of extensible plastic material that is unwound from a reel comprising:
a first pre-stretching roller and a second pre-stretching roller rotatable about respective longitudinal rotation axes and arranged to unwind and pre-stretch said film;
a motion transmission system configured to connect said pre-stretching rollers to each other and transmit a rotation motion from said first pre-stretching roller to said second pre-stretching roller with at least one defined transmission ratio, said motion transmission system comprising:
at least two toothed driving wheels having different respective numbers of teeth, mounted coaxial and integral to each other, and rotated by said pre-stretching roller;
at least two toothed driven wheels having different respective numbers of teeth, mounted coaxial to said second pre-stretching roller and selectively couplable to said second pre-stretching roller, each toothed driven wheel meshing with a respective toothed driving wheels in order to transmit the rotation motion of the first pre-stretching roller to the second pre-stretching roller with a corresponding transmission ratio when said toothed driven wheel is coupled to said second pre-stretching roller;
a selector device that can be operated to couple a toothed driven wheel at a time to said second pre-stretching roller;
wherein said selector device comprises:
a driven shaft connected to said second pre-stretching roller, rotatably supporting said toothed driven wheels and provided with a longitudinal internal cavity having at least one first lateral through opening and one second lateral through opening suitable for housing respective locking elements;
a selector pin sliding inside said internal cavity and provided with at least one first transverse protrusion and one second transverse protrusion, said selector pin being movable at least between a first operative position, in which said first transverse protrusion abuts and pushes at least one locking element to protrude externally from said first lateral through opening so as to engage a first seat of said first toothed driven wheel and to couple the first toothed driven wheel to said driven shaft, and a second operative position, in which said second transverse protrusion abuts and pushes at least one locking element to protrude externally from said second lateral through opening so as to engage a second seat of said second toothed driven wheel and to couple the second toothed driven wheel to said driven shaft.

13. The unwinding apparatus according to claim 12, wherein said at least one first lateral through opening and said at least one second lateral through opening are spaced along a direction parallel to a longitudinal axis of said driven shaft.

14. The unwinding apparatus according to claim 12, wherein said internal cavity of said driven shaft comprises a plurality of first lateral through openings angularly spaced about a longitudinal axis of said driven shaft and suitable for housing respective locking element and a plurality of second lateral through openings angularly spaced about the longitudinal axis and suitable for housing respective locking elements.

15. The unwinding apparatus according to claim 12, wherein said selector pin has a cylindrical shape and each transverse protrusion comprises a conical portion and a cylindrical portion respectively configured to push the locking element to protrude externally from the lateral through openings and to keep the locking element protruding externally from said lateral through openings.

16. The unwinding apparatus according to claim 12, wherein said first toothed driven wheel and said second toothed driven wheel comprise respective central openings suitable for coupling with said driven shaft and provided with a plurality respectively of first seats and second seats suitable for receiving said locking elements.

17. The unwinding apparatus according to claim 12, wherein said selector pin is movable in an inoperative position in which said first transverse protrusion and said second transverse protrusion do not abut said locking elements and said toothed driven wheels idly rotate on said driven shaft.

18. The unwinding apparatus according to claim 12, wherein said selector device comprises a locking assembly acting on said selector pin and configured to reversibly lock said selector pin at least in said first operative position or in said second operative position.

19. The unwinding apparatus according to claim 18, wherein said locking assembly comprises at least one elastic pressing element and at least a first and a second annular groove of said selector pin, said elastic pressing element being configured to engage said first annular groove in said first operative position or said second annular groove in said second operative position of said selector pin.

20. The unwinding apparatus according to claim 12, wherein said selector pin comprises a gripping end which protrudes from an access opening of said internal cavity and is arranged opposite to said second pre-stretching roller.

21. The unwinding apparatus according to claim 12, comprising a motor arranged to rotate said first pre-stretching roller.

22. The unwinding apparatus according to claim 12, wherein said motion transmission system comprises a number of driven wheel that is equal to the number of toothed driving wheel, each toothed driven wheel engaging a respective specific toothed driving wheel.

23. The unwinding apparatus according to claim 13, wherein said first and second lateral through openings are orthogonal to said longitudinal axis.
